(19) United States
(12) Patent Application Publication
(10) Pub. No.: US 2025/0036886 A1
(43) Pub. Date: Jan. 30, 2025

(54) Tool Documentation Enables Zero-Shot Tool-Usage With Large Language Models

(71) Applicant: Google LLC, Mountain View, CA (US)

(72) Inventors: Chen-Yu Lee, Cupertino, CA (US); Alexander Ratner, Menlo Park, CA (US); Tomas Pfister, Redwood City, CA (US); Chun-Liang Li, Santa Clara, CA (US); Yasuhisa Fujii, Tokyo (JP); Ranjay Krishna, Seattle, WA (US); Cheng-Yu Hsieh, Seattle, WA (US); Si-An Chen, Taipei City (TW)

(21) Appl. No.: 18/766,812

(22) Filed: Jul. 9, 2024

Related U.S. Application Data
(60) Provisional application No. 63/529,185, filed on Jul. 27, 2023.

(51) Int. Cl. G06F 40/40; G06N 3/0475

(52) U.S. Cl. CPC G06F 40/40; G06N 3/0475

(57) ABSTRACT

Using a large language model to comply with a user request. The large language model receives tool documentation for each of one or more tools, and analyzes the tool documentation for each of the one or more tools to determine, for each tool, one or more tasks that the tool is operable to perform. Upon receiving a request from a user, the large language model generates a plan for complying with the request by using one or more of the tools, the plan including performance of one or more of the tasks.

### CROSS-REFERENCE TO RELATED APPLICATIONS

The present application claims the benefit of the filing date of U.S. Provisional Application No. 63/529,185 filed on Jul. 27, 2023, the disclosure of which is hereby incorporated herein by reference.

### BACKGROUND

Large language models are taught to use new tools by providing a few demonstrations of the tools' usage. Unfortunately, demonstrations are hard to acquire, and can result in undesirable biased usage if the wrong demonstration is chosen. Even in the rare scenario that demonstrations are readily available, there is no principled selection protocol to determine how many and which ones to provide. As tasks grow more complex, the selection search grows combinatorially and invariably becomes intractable.

### BRIEF SUMMARY

The presently disclosed technology provides alternatives to teaching large language models using demonstrations. In accordance with the presently disclosed technology, large language models (LLMs) learn from tool documentation—descriptions for individual tool usage—instead of learning from demonstrations. Further, in accordance with the technology, LLMs may learn from a combination of tool documentation and demonstrations.

In one aspect, the presently disclosed technology provides a computing system including a communication interface for receiving tool documentation for each of one or more tools; and a large language model for analyzing the tool documentation for each of the one or more tools to determine, for each tool, one or more tasks that the tool is operable to perform, receiving a request from a user, and generating a plan for complying with the request by using one or more of the tools, the plan including performing one or more of the tasks.

In another aspect, the presently disclosed technology provides a method for using a large language model to comply with a user request, including providing the large language model with tool documentation for each of one or more tools; and using the large language model to analyze the tool documentation for each of the one or more tools to determine, for each tool, one or more tasks that the tool is operable to perform, receive a request from a user, and generate a plan for complying with the request by using one or more of the tools, the plan including performance of one or more of the tasks.

In still another aspect, the presently discloses technology provides a non-transitory computer-readable medium having stored thereon computer-readable instructions for using a large language model to comply with a user request, the instructions causing a computing system to receive, at a large language model, tool documentation for each of one or more tools; and use the large language model to analyze the tool documentation for each of the one or more tools to determine, for each tool, one or more tasks that the tool is operable to perform, receive a request from a user, and generate a plan for complying with the request by using one or more of the tools, the plan including performance of one or more of the tasks.

### BRIEF DESCRIPTION OF THE DRAWINGS

The accompanying drawings are not intended to be drawn to scale. Also, for purposes of clarity not every component may be labeled in every drawing. In the drawings:

FIG. 1 is a high-level system diagram of an exemplary processing system for performing the functions and methods described herein.

FIG. 2 is a high-level system diagram 200 in which the exemplary processing system of FIG. 1 is shown in communication with various websites and/or remote storage systems over one or more networks.

FIG. 3 is a functional block diagram for illustrating the interaction between a user and an LLM and between the LLM and a tool.

FIG. 4 is a functional block diagram showing how an LLM may process a user request.

FIG. 5 shows examples of tool documentation that may be provided to an LLM, with examples of demonstrations included in the figure for purposes of comparison.

FIG. 6 is a flow chart showing operations that may be performed according to embodiments when using an LLM to comply with a user request.

### DETAILED DESCRIPTION

Examples of systems and methods are described herein. It should be understood that the words “example,” “exemplary” and “illustrative” are used herein to mean “serving as an example, instance, or illustration.” Any embodiment or feature described herein as being an “example,” “exemplary” or “illustration” is not necessarily to be construed as preferred or advantageous over other embodiments or features. In the following description, reference is made to the accompanying figures, which form a part thereof. In the figures, similar symbols typically identify similar components, unless context dictates otherwise. Other embodiments may be utilized, and other changes may be made, without departing from the spirit or scope of the subject matter presented herein.

The example embodiments described herein are not meant to be limiting. It will be readily understood that the aspects of the present disclosure, as generally described herein, and illustrated in the figures, can be arranged, substituted, combined, separated, and designed in a wide variety of different configurations, all of which are explicitly contemplated herein.

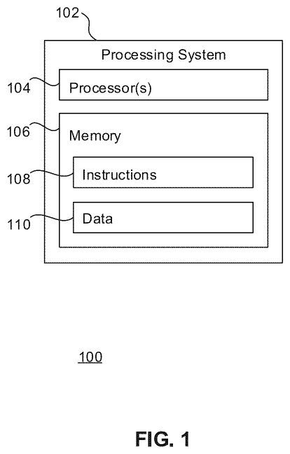

FIG. 1 shows a high-level system diagram 100 of an exemplary processing system 102 for performing the functions and methods described herein. The processing system 102 may include one or more processors 104 and memory 106 storing instructions 108 and data 110. The instructions 108 and/or data 110 may cause the system 102 to operate as any of the large language models (LLMs) described herein. In addition, the data 110 may store tool documentation and/or demonstrations to be used by such LLMs to generate plans for complying with user requests. Processing system 102 may be resident on a single computing device. For example, processing system 102 may be a server, personal computer, or mobile device, and a sequence model may thus be local to that single computing device. Similarly, processing system 102 may be resident on a cloud computing system or other distributed system. In such a case, a LLM may be distributed across two or more different physical computing devices.

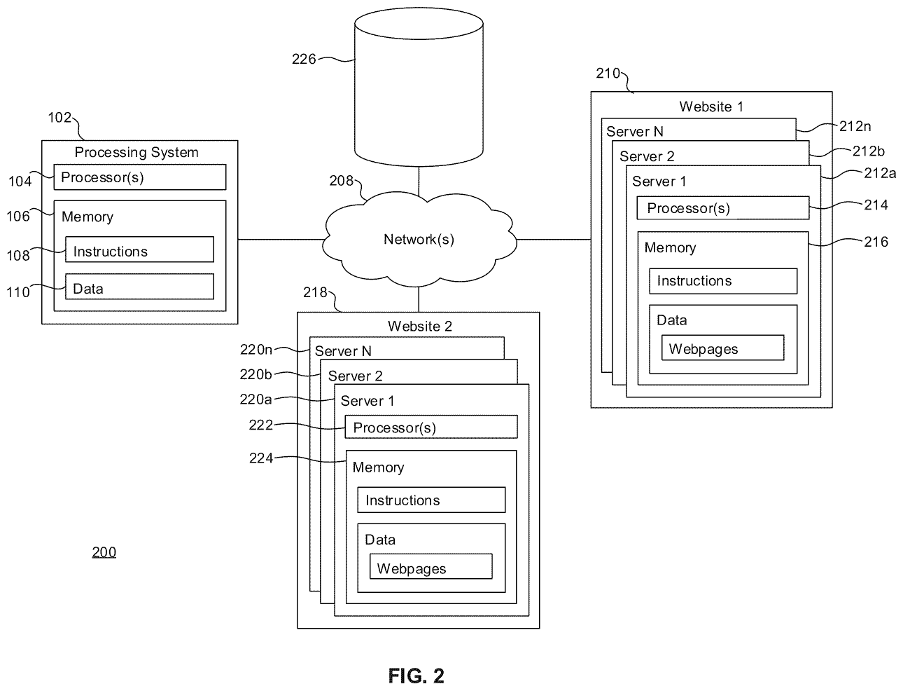

Further in this regard, FIG. 2 shows a high-level system diagram 200 in which the exemplary processing system 102 just described is shown in communication with various websites and/or remote storage systems over one or more networks 208, including websites 210 and 218 and remote storage system 226. In this example, websites 210 and 218 each include one or more servers 212a-212n and 220a-220n, respectively. Each of the servers 212a-212n and 220a-220n may have one or more processors (e.g., 214 and 222), and associated memory (e.g., 216 and 224) storing instructions and data, including the content of one or more web pages. Likewise, although not shown, remote storage system 226 may also include one or more processors and memory storing instructions and data. In some aspects of the technology, the processing system 102 may be configured to retrieve tool documentation from external tools (e.g., search engines, messaging applications, and video conferencing applications) associated with one or more of website 210, website 218, and/or remote storage system 226, and provide the tool documentation to an LLM for use in generating plans for complying with user requests. For instance, an LLM may respond to a user request to solicit applications for a job based on tool information concerning a job search website, an automated email generation application, and tele-conference scheduling application.

The processing systems described herein may be implemented on any type of computing device(s), such as any type of general computing device, server, or set thereof, and may further include other components typically present in general purpose computing devices or servers. Likewise, the memory of such processing systems may be of any non-transitory type capable of storing information accessible by the processor(s) of the processing systems. For instance, the memory may include a non-transitory medium such as a hard-drive, memory card, optical disk, solid-state, tape memory, or the like. Computing devices suitable for the roles described herein may include different combinations of the foregoing, whereby different portions of the instructions and data are stored on different types of media.

In all cases, the computing devices described herein may further include any other components normally used in connection with a computing device such as a user interface subsystem. The user interface subsystem may include one or more user inputs (e.g., a mouse, keyboard, touch screen and/or microphone) and one or more electronic displays (e.g., a monitor having a screen or any other electrical device that is operable to display information). Output devices besides an electronic display, such as speakers, lights, and vibrating, pulsing, or haptic elements, may also be included in the computing devices described herein.

The one or more processors included in each computing device may be any conventional processors, such as commercially available central processing units (“CPUs”), graphics processing units (“GPUs”), tensor processing units (“TPUs”), etc. Alternatively, the one or more processors may be a dedicated device such as an ASIC or other hardware-based processor. Each processor may have multiple cores that are able to operate in parallel. The processor(s), memory, and other elements of a single computing device may be stored within a single physical housing, or may be distributed between two or more housings. Similarly, the memory of a computing device may include a hard drive or other storage media located in a housing different from that of the processor(s), such as in an external database or networked storage device. Accordingly, references to a processor or computing device will be understood to include references to a collection of processors or computing devices or memories that may or may not operate in parallel, as well as one or more servers of a load-balanced server farm or cloud-based system.

The computing devices described herein may store instructions capable of being executed directly (such as machine code) or indirectly (such as scripts) by the processor(s). The computing devices may also store data, which may be retrieved, stored, or modified by one or more processors in accordance with the instructions. Instructions may be stored as computing device code on a computing device-readable medium. In that regard, the terms “instructions” and “programs” may be used interchangeably herein. Instructions may also be stored in object code format for direct processing by the processor(s), or in any other computing device language including scripts or collections of independent source code modules that are interpreted on demand or compiled in advance. By way of example, the programming language may be C#, C++, JAVA or another computer programming language. Similarly, any components of the instructions or programs may be implemented in a computer scripting language, such as JavaScript, PHP, ASP, or any other computer scripting language. Furthermore, any one of these components may be implemented using a combination of computer programming languages and computer scripting languages.

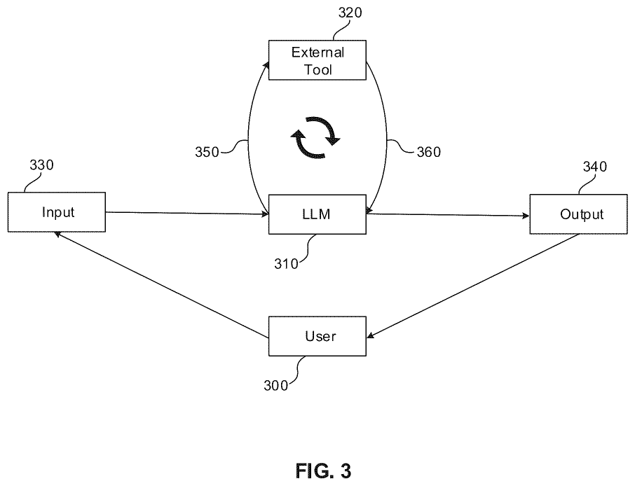

FIG. 3 is a functional block diagram for illustrating the interaction between a user 300 and an LLM 310 and between the LLM 310 and a tool 320. As can be seen from FIG. 3, the user 300 may provide an input 330 to the LLM 310, such as a question, prompt, or query in audio, visual, and/or text form, and the LLM 310 may provide an output 340 to the user 300, such as an answer in audio, visual, and/or text form. To provide the answer, the LLM 310 may provide the tool 320 with tool inputs 350 and receive tool outputs 360 from the tool 320. In some embodiments, the tool outputs 360 may include outputs that cause the LLM 310 to query the user 300, e.g., to query the user 300 for additional information required by the tool 320, and the tool inputs 350 may include responses to such queries.

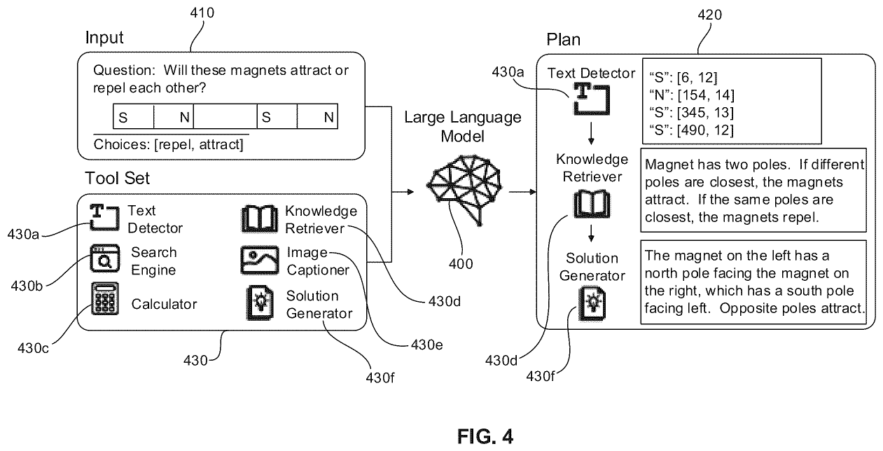

By way of example, the user 300 may be the processing system 102 of FIG. 2, or a person operating through processing system 102 of FIG. 2. The LLM 310 may be associated with Website 1 210 of FIG. 2 and executing on one of Servers 212a-212n, the tool 320 may be associated with Website 2 218 of FIG. 2 and executing on one of Servers 220a-220n, and the user 300, LLM 310, and tool 320 may be communicatively coupled through network 208 of FIG. 2. Nevertheless, the configuration of FIG. 3 is merely illustrative. For example, the LLM 310 may be coupled to a multiple of tools, and need not provide an output 340 to the user 300. Instead of providing an output 340 to the user 300, the LLM 310 may respond to input 330 by performing a function that does not yield user output 340. For instance, the LLM 310 may be used to execute certain commands for deploying virtual machines on cloud computing platforms. Moreover, the LLM 310 need not receive a tool output 360, but rather, may provide a tool input 350 that does not yield a tool output 360. For example, the LLM 310 can call external Application Programming Interfaces (APIs) with corresponding input arguments needed to complete specific user instructions. In accordance with embodiments, when an LLM, e.g., LLM 310, is asked to perform a complex task, the LLM 310 decomposes the task into simpler sub-tasks and assembles the best possible tool(s), e.g., tool 320, to tackle each sub-task. To illustrate how an LLM performs a complex task reference is made to FIG. 4.

FIG. 4 is a functional block diagram showing how an LLM 400 may process a user request 410. As shown in FIG. 4, the LLM 400 receives the user request 410 as an input and generates a plan 420 for complying with the request 410 through the use of a tool set 430. The elements of FIG. 4 may be implemented in the context of FIG. 3, with the LLM 400 corresponding to the LLM 310, the user request 410 corresponding to the input 330 generated by the user 300, the tool set 430 corresponding to a multiple of tools including the tool 320, and the plan 420 being used to generate the output 340. The tool set 430 may include, for example, a text detector 430a (e.g., an optical character recognition (OCR) model), a search engine 430b, a calculator 430c, a knowledge retriever 430d (e.g., Wikipedia), an image captioner 430c, and a solution generator 430f (e.g., an LLM other than LLM 400). By way of illustration, each of tools 430a-430f may take the form of software that is accessible by way of API calls.

In the depiction of FIG. 4, the LLM 400 is presented with a multi-modal question answering task. Given the input 410 of a question with an image, the LLM 400 selects appropriate tools from the tool set 430 and generates an execution plan 420 to answer the question correctly. Here, the LLM 400 outlines a plan 420 to first use the text detector 430a to understand the positioning of the magnets in the image, then uses the knowledge retriever 430d to obtain relevant background knowledge about magnets, then finally generates the solution by using the solution generator 430f based on the results of the previous steps. Notably, the LLM 400 must learn the tools 430a-430f to be able to use them.

In accordance with embodiments, LLMs are taught to use tools through documentation. Similar to a manual indicating a physical tool's capabilities, a software tool's documentation may outline what the tool can and cannot be used for and how to invoke the tool. Documentation provides relatively neutral instruction about the tools' functionalities and how individual tools should be used. Further, documentation is usually readily available as it is generally created as part of the tool introduction process. In embodiments, LLMs are provided with README files when encountering a new tool/repository and do not need demos to use a new tool. Nevertheless, in some embodiments, tool use by an LLM may be based upon both documentation (docs) and demos, the number of demos varying from few-shot down to one-shot. Testing of the presently disclosed technology indicates that in many cases, when provided with tool docs, LLMs' zero-shot tool-using performance is better than their few-shot counterparts, showing that including docs is an effective way to sidestep demos while improving performance. Accordingly, using the presently disclosed technology one can efficiently scale up to a significantly larger tool set, e.g., on a newly collected API usage dataset, by simply providing the LLMs with docs. Thereby, providing a way to seamlessly add new tools along with their docs to a tool set for LLMs to solve unseen tasks, all without any further demos and in a plug-and-play manner.

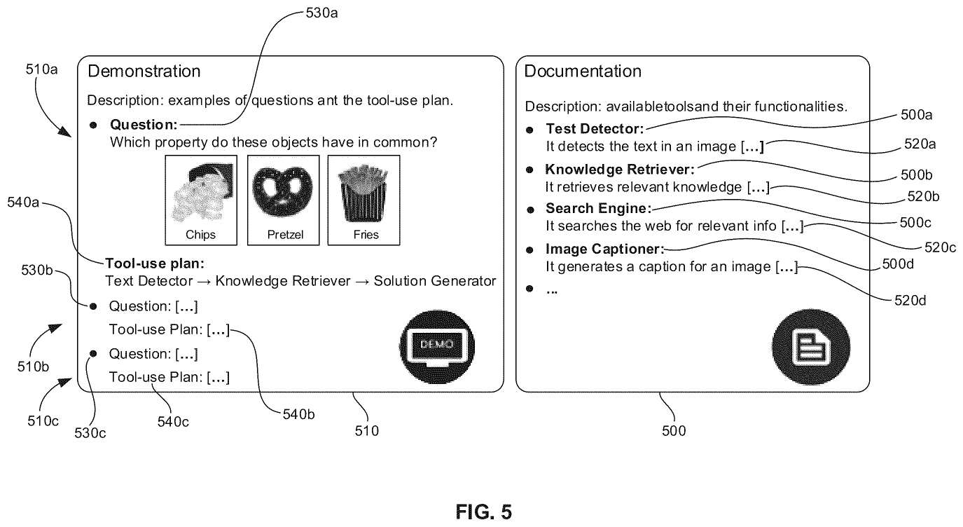

For example, LLM 400 of FIG. 4 may be taught to use tools 430a-430f by providing the LLM 400 with documentation for each of tools 430a-430f, e.g., README text files created by the owner(s) of the tools 430a-430f for purposes of describing the tools 430a-430f. Further, in accordance with other embodiments, LLMs are taught to use tools through both docs and demonstration. Regarding teaching an LLM through demonstration, the process includes providing the LLM with one or more exemplars from which the LLM is expected to find a pattern which can be applied to user requests. That is, teaching an LLM through demonstration involves providing the LLM with one or more exemplars each including a request and a tool-use plan for complying with the request, after which, the LLM divines tool-use patterns in the exemplars and generalizes the patterns for application to new tasks. Regarding teaching an LLM through documentation, the process includes providing the LLM with tool documentation which the LLM analyzes to determine, for each tool, one or more tasks that the tool is operable to perform. For example, the analysis may include analyzing the text of the documentation (e.g., a description of the website service booking.com) to determine combinations of LLM prompt words that will trigger an API call to the tool (e.g., a prompt of “Find me a flight to place X” triggers the LLM to send an API call to booking.com to initiate a search for flights to place X and return the result). After the tool documentation has been analyzed, when a user request is received, a plan is generated for complying with the request by using one or more of the tools, the plan involving performing one or more of the tasks. To illustrate, the presently disclosed use of documentation FIG. 5 is provided.

FIG. 5 shows examples of tool documentation 500 that may be provided to an LLM in accordance with embodiments, with examples of demonstrations 510 included in the figure for purposes of comparison. As can be seen from FIG. 5, documentation 500 may be provided for a variety of tools, such as a text detector 500a, a knowledge retriever 500b, a search engine 500c, and an image captioner 500d; and for each of tools 500a-500d, a respective tool description is provided, e.g., text detector description 520a, knowledge retriever description 520b, search engine description 520c, and image captioner description 520d. Each of the tool descriptions may be in the form of at least one of a README text file describing the general purpose of the tool; or may be in the form of at least one more detailed description, e.g., specifying how the tool can be used to achieve various functionality through setting different input arguments for an API call. Regarding the demonstrations 510, three such demonstrations 510a, 510b, and 510c are depicted, with demonstration 510a shown in more detail than demonstrations 510b and 510c. As can be seen, each of the demonstrations 510a-510c includes a question, respectively questions 530a, 530b, and 530c, and a tool-use plan, respectively tool-use plans 540a, 540b, and 540c. In the case of demonstration 510a, an LLM is provided with captioned pictures of three different food objects, a question “Which property do these objects have in common?”, and a tool-use plan for answering the question, the plan including using a text detector, a knowledge retriever, and a solution generator. For instance, the text detector would be used to detect the names of the objects in the pictures, the knowledge retriever (e.g., Wikipedia) to gather information associated with detected names, and the solution generator (e.g., another LLM such as text-davinci-002 or gpt-3.5-turbo) to determine similarities through language analysis of the gathered information.

Regarding tools more generally, it should be noted that, while some tools have been explicitly mentioned in this disclosure, the embodiments are not limited to the tools explicitly mentioned. Upon review of this disclosure, one will readily appreciate the wide range of tools that may be “learned” by an LLM through documentation. By way of illustration, some previously unmentioned tools that may be used by an LLM in accordance with embodiments include any off-the-shelf models such as GroundingDINO, Stable Diffusion, XMem, Segment Anything (SAM), Grounded-SAM, and Track Anything.

It should also be noted that tool documentation used to teach an LLM may specify one or more input parameters. That is, the tool documentation used to teach an LLM may specify one or more parameters that the tool requires as input for performing a given task, and thereby the LLM may learn required inputs for the task from the documentation. Similarly, the tool documentation used to teach an LLM may specify one or more output parameters for a given task, so that the LLM may learn the parameters to send to a user upon performing the task.

In any event, in some embodiments available tool documentation may be truncated before being provided to an LLM for learning. Such truncation is advantageous in situations where an LLM's ability to comprehend a document degrades when the document exceeds a certain length. Truncation may be performed manually, or it may be performed automatically. For instance, referring to FIG. 3, if the user 300 provides LLM 310 with documentation through input 330 the user 300 truncate any lengthy documentation before the user 300 forwards the documentation to the LLM 310; or the user 300 may be running software that automatically analyzes tool documentation that is to be forwarded to the LLM 310 and truncates such documentation, as necessary, in an automated manner.

It should be noted that in some embodiments, F1 Score for an LLM begins to degrade at a document length of about 600 words, and thus manual or automatic truncation may be triggered for a tool when the tool's documentation has about 600 or more words.

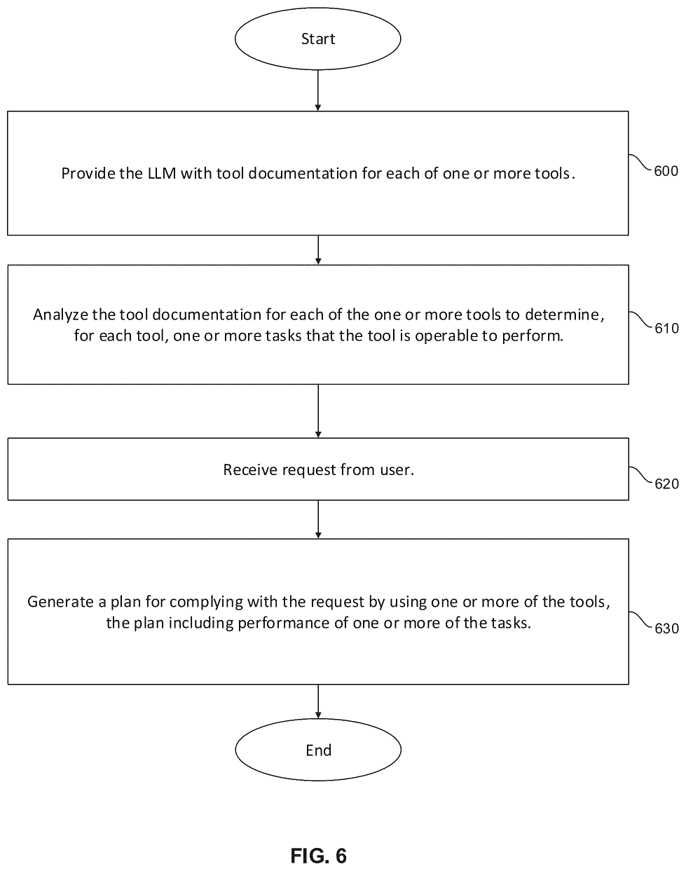

Turning now to FIG. 6, the figure is a flow chart showing operations that may be performed according to embodiments when using an LLM to comply with a user request. As can be seen from FIG. 6, an initial step may be providing the LLM with tool documentation for each of one or more tools (step 600). Next, the LLM is used to analyze the tool documentation for each of the one or more tools to determine, for each tool, one or more tasks that the tool is operable to perform (step 610). Then, when a request is received from a user (step 615), the LLM responds to the request by generating a plan for complying with the request by using one or more of the tools, the plan including performance of one or more of the tasks (step 620). As an option, the tool documentation may be provided to the LLM with a user request, in which case step 600 includes providing a user request to the LLM and step 620 is not necessary.

Embodiments of the present technology include, but are not restricted to, the following.
(1) A computing system including a communication interface for receiving tool documentation for each of one or more tools; and a large language model for analyzing the tool documentation for each of the one or more tools to determine, for each tool, one or more tasks that the tool is operable to perform, receiving a request from a user, and generating a plan for complying with the request by using one or more of the tools, the plan including the performance of one or more of the tasks.
(2) The computing system according to (1), wherein the tool documentation and the request are part of a large language model prompt that is received via the communication interface.
(3) The computing system according to (1), wherein the tool documentation for at least one of the tools includes a description of the tool written by a provider of the tool.
(4) The computing system according to (1), wherein the tool documentation for at least one of the tools specifies one or more input parameters.
(5) The computing system according to (1), wherein the tool documentation for at least one of the tools specifies one or more output parameters.
(6) The computing system according to (1), wherein the one or more tools include one or more websites.
(7) The computing system according to (6), wherein the one or more websites includes at least one of a search engine, a messaging application, a conferencing application, or an image recognition application.
(8) The computing system according to (1), wherein the plan for complying with the request includes the performance of one or more image recognition tasks.
(9) The computing system according to (1), wherein the large language model is operable to receive one or more demonstrations, and generating the plan further includes generating the plan based on the one or more demonstrations.
(10) The computing system according to (1), wherein the large language model is operable to query the user in response to the request, and generating the plan further includes generating the plan based on a reply to the query.
(11) The computing system according to (1), wherein the tool documentation for at least one of the tools includes a truncated description of the tool.
(12) A method for using a large language model to comply with a user request, including providing the large language model with tool documentation for each of one or more tools; and using the large language model to analyze the tool documentation for each of the one or more tools to determine, for each tool, one or more tasks that the tool is operable to perform, receive a request from a user, and generate a plan for complying with the request by using one or more of the tools, the plan including performance of one or more of the tasks.
(13) The method according to (12), wherein the tool documentation and the request are part of a large language model prompt that is received at the large language model.
(14) The method according to (12), wherein the one or more tools include one or more websites.
(15) The method according to (14), wherein the one or more websites includes at least one of a search engine, a messaging application, a conferencing application, or an image recognition application.
(16) The method according to (12), wherein the tool documentation for at least one of the tools includes a description of the tool written by a provider of the tool.
(17) The method according to (12), wherein the method further includes receiving one or more demonstrations at the large language model, and using the large language model to generate the plan further includes generating the plan based on the one or more demonstrations.
(18) The method according to (12), further including using the large language model to query the user in response to the request, and using the large language model to generate the plan further includes generating the plan based on a reply to the query.
(19) The method according to (12), wherein providing the large language model with tool documentation for each of one or more tools includes, for at least one of the tools, truncating a description of the tool to generate a truncated description and using the truncated description as the tool documentation.
(20) A non-transitory computer-readable medium having stored thereon computer-readable instructions for using a large language model to comply with a user request, the instructions causing a computing system to receive, at a large language model, tool documentation for each of one or more tools; and use the large language model to analyze the tool documentation for each of the one or more tools to determine, for each tool, one or more tasks that the tool is operable to perform, receive a request from a user, and generate a plan for complying with the request by using one or more of the tools, the plan including performance of one or more of the tasks.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description should be taken by way of illustration rather than by way of limitation of the subject matter defined by the claims.

1. A computing system comprising:
a communication interface for receiving tool documentation for each of one or more tools; and
a large language model for analyzing the tool documentation for each of the one or more tools to determine, for each tool, one or more tasks that the tool is operable to perform, receiving a request from a user, and generating a plan for complying with the request by using one or more of the tools, the plan comprising the performance of one or more of the tasks.

2. The computing system according to claim 1, wherein the tool documentation and the request are part of a large language model prompt that is received via the communication interface.

3. The computing system according to claim 1, wherein the tool documentation for at least one of the tools comprises a description of the tool written by a provider of the tool.

4. The computing system according to claim 1, wherein the tool documentation for at least one of the tools specifies one or more input parameters.

5. The computing system according to claim 1, wherein the tool documentation for at least one of the tools specifies one or more output parameters.

6. The computing system according to claim 1, wherein the one or more tools comprise one or more websites.

7. The computing system according to claim 6, wherein the one or more websites comprise at least one of a search engine, a messaging application, a conferencing application, or an image recognition application.

8. The computing system according to claim 1, wherein the plan for complying with the request comprises the performance of one or more image recognition tasks.

9. The computing system according to claim 1, wherein the large language model is operable to receive one or more demonstrations, and generating the plan further comprises generating the plan based on the one or more demonstrations.

10. The computing system according to claim 1, wherein the large language model is operable to query the user in response to the request, and generating the plan further comprises generating the plan based on a reply to the query.

11. The computing system according to claim 1, wherein the tool documentation for at least one of the tools comprises a truncated description of the tool.

12. A method for using a large language model to comply with a user request, comprising:
providing the large language model with tool documentation for each of one or more tools; and
using the large language model to analyze the tool documentation for each of the one or more tools to determine, for each tool, one or more tasks that the tool is operable to perform, receive a request from a user, and generate a plan for complying with the request by using one or more of the tools, the plan comprising performance of one or more of the tasks.

13. The method according to claim 12, wherein the tool documentation and the request are part of a large language model prompt that is received at the large language model.

14. The method according to claim 12, wherein the one or more tools comprise one or more websites.

15. The method according to claim 14, wherein the one or more websites comprise at least one of a search engine, a messaging application, a conferencing application, or an image recognition application.

16. The method according to claim 12, wherein the tool documentation for at least one of the tools comprises a description of the tool written by a provider of the tool.

17. The method according to claim 12, wherein the method further comprises receiving one or more demonstrations at the large language model, and using the large language model to generate the plan further comprises generating the plan based on the one or more demonstrations.

18. The method according to claim 12, further comprising using the large language model to query the user in response to the request, and using the large language model to generate the plan further comprises generating the plan based on a reply to the query.

19. The method according to claim 12, wherein providing the large language model with tool documentation for each of one or more tools comprises, for at least one of the tools, truncating a description of the tool to generate a truncated description and using the truncated description as the tool documentation.

20. A non-transitory computer-readable medium having stored thereon computer-readable instructions for using a large language model to comply with a user request, the instructions causing a computing system to:
receive, at a large language model, tool documentation for each of one or more tools; and
use the large language model to analyze the tool documentation for each of the one or more tools to determine, for each tool, one or more tasks that the tool is operable to perform, receive a request from a user, and generate a plan for complying with the request by using one or more of the tools, the plan comprising performance of one or more of the tasks.
